(19) United States
(12) Patent Application Publication
(10) Pub. No.: US 2023/0230038 A1
(43) Pub. Date: Jul. 20, 2023

(54) CROSS-REGIONAL TALENT FLOW INTENTION ANALYSIS METHOD, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Ying SUN, Beijing (CN); Hengshu ZHU, Beijing (CN); Chuan QIN, Beijing (CN); Peng WANG, Beijing (CN); Hui XIONG, Beijing (CN)

(73) Assignee: BEIJING BAIDU NETCOM SCIENCE TECHNOLOGY CO., LTD., Beijing (CN)

(21) Appl. No.: 17/945,168

(22) Filed: Sep. 15, 2022

(30) Foreign Application Priority Data
Jan. 19, 2022 (CN) 202210061771.6

(51) Int. Cl. G06Q 10/10; G06F 16/906

(52) U.S. Cl. CPC G06Q 10/1053; G06F 16/906

(57) ABSTRACT

There is provided a method for cross-regional talent flow intention analysis, an electronic device, and a storage medium, which relates to technical fields such as big data processing and data statistics and analysis. A specific implementation solution involves: constructing a talent flow intention network based on search data in a network within a preset period of time; and performing cross-regional talent flow intention analysis based on the talent flow intention network to obtain a talent flow intention analysis result.

### CROSS-REFERENCE TO RELATED APPLICATIONS

The present application claims the priority of Chinese Patent Application No. 202210061771.6, filed on Jan. 19, 2022, with the title of “CROSS-REGIONAL TALENT FLOW INTENTION ANALYSIS METHOD AND APPARATUS, ELECTRONIC DEVICE, AND STORAGE MEDIUM.” The disclosure of the above application is incorporated herein by reference in its entirety.

### FIELD OF THE DISCLOSURE

The present disclosure relates to the technical field of computers, specifically to technical fields such as big data processing and data statistics and analysis, and particularly to a method for cross-regional talent flow intention analysis, an electronic device, and a storage medium.

### BACKGROUND OF THE DISCLOSURE

Labor may flow between regions due to a dynamic nature of a labor market. Such flow has a great impact on regional development. Some regions may be slowed down by outflow of talent, and some regions may be accelerated by growth of talent.

Analysis on talent flow can help to better monitor and predict a current situation and trend of regional development. Conventionally, regional talent changes are generally analyzed through official statistics. For example, officials may regularly organize manual surveys of an employment market and release related statistics.

### SUMMARY OF THE DISCLOSURE

The present disclosure provides a method for cross-regional talent flow intention analysis, an electronic device, and a storage medium.

According to one aspect of the present disclosure, a method for cross-regional talent flow intention analysis is provided, including constructing a talent flow intention network based on search data in a network within a preset period of time; and performing cross-regional talent flow intention analysis based on the talent flow intention network to obtain a talent flow intention analysis result.

According to another aspect of the present disclosure, an electronic device is provided, including at least one processor; and a memory communicatively connected with the at least one processor; wherein the memory stores instructions executable by the at least one processor, and the instructions are executed by the at least one processor to enable the at least one processor to perform a method for cross-regional talent flow intention analysis, wherein the method includes constructing a talent flow intention network based on search data in a network within a preset period of time; and performing cross-regional talent flow intention analysis based on the talent flow intention network to obtain a talent flow intention analysis result.

According to still another aspect of the present disclosure, there is provided a non-transitory computer readable storage medium with computer instructions stored thereon, wherein the computer instructions are used for causing a method for cross-regional talent flow intention analysis, wherein the method includes constructing a talent flow intention network based on search data in a network within a preset period of time; and

performing cross-regional talent flow intention analysis based on the talent flow intention network to obtain a talent flow intention analysis result.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The accompanying drawings are intended to provide a better understanding of the solutions and do not constitute a limitation on the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure; and

FIG. 5 is a block diagram of an electronic device configured to implement a method according to an embodiment of the present disclosure.

### DETAILED DESCRIPTION OF PREFERRED EMBODIMENTS

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

Obviously, the embodiments described are some of rather than all of the embodiments of the present disclosure. All other embodiments acquired by those of ordinary skill in the art without creative efforts based on the embodiments of the present disclosure fall within the protection scope of the present disclosure.

It is to be noted that the terminal device involved in the embodiments of the present disclosure may include, but is not limited to, smart devices such as mobile phones, personal digital assistants (PDAs), wireless handheld devices, and tablet computers. The display device may include, but is not limited to, devices with a display function such as personal computers and televisions.

In addition, the term “and/or” herein is merely an association relationship describing associated objects, indicating that three relationships may exist. For example, A and/or B indicates that there are three cases of A alone, A and B together, and B alone. Besides, the character “/” herein generally means that associated objects before and after it are in an “or” relationship.

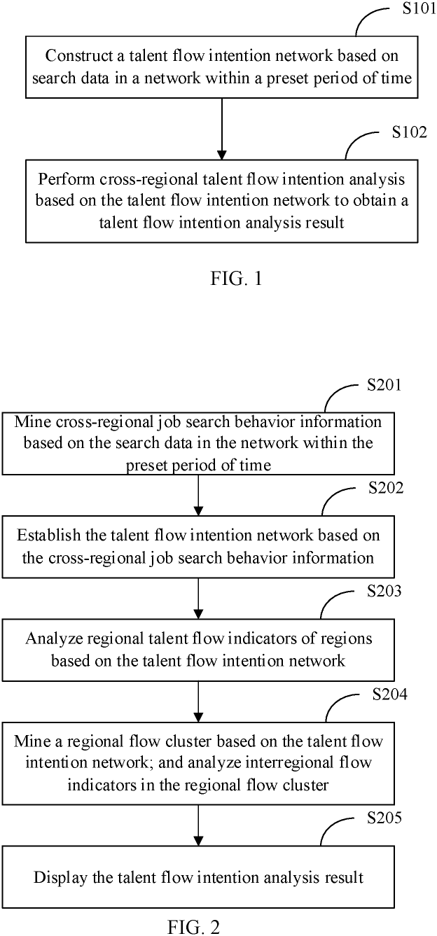

FIG. 1 is a schematic diagram according to a first embodiment of the present disclosure. As shown in FIG. 1, this embodiment provides a method for cross-regional talent flow intention analysis, which may be applied to any computer device capable of realizing talent flow intention analysis and may specifically include the following steps.

In S101, a talent flow intention network is constructed based on search data in a network within a preset period of time.

In S102, cross-regional talent flow intention analysis is performed based on the talent flow intention network to obtain a talent flow intention analysis result.

Talent flow is not instantaneous. Therefore, in this embodiment, the talent flow intention network is constructed based on search data in the network within the preset period of time. The preset period of time may be selected as required, which may be, for example, one month, one quarter, one year, or other time lengths set based on actual requirements.

With rapid popularization of the Internet, online search engines have become a part of people’s life. Compared with other data sources, search engine queries can naturally reflect a variety of user requirements and intentions, and are suitable for a wide range of user behavior analysis.

Moreover, the search engines have a wider user base and can perform less biased analysis. When people are interested in job transfer, many may turn to online search engines for job information. Based on this, in this embodiment, a talent flow intention network may be constructed based on search data in a network within a preset period of time, and then cross-regional talent flow intention analysis may be performed based on the talent flow intention network to obtain a talent flow intention analysis result.

According to the method for cross-regional talent flow intention analysis in this embodiment, by constructing a talent flow intention network based on search data in a network within a preset period of time and then performing cross-regional talent flow intention analysis based on the talent flow intention network, an efficient talent flow intention analysis scheme can be provided. Compared with offline manual surveys and analysis, the method not only has lower costs, but also has more reliable and available data sources and better real-time performance.

FIG. 2 is a schematic diagram according to a second embodiment of the present disclosure. As shown in FIG. 2, a method for cross-regional talent flow intention analysis in this embodiment further describes the technical solution of the present disclosure in more detail on the basis of the technical solution in the embodiment shown in FIG. 1. As shown in FIG. 2, the method for cross-regional talent flow intention analysis in this embodiment may specifically include the following steps.

In S201, cross-regional job search behavior information is mined based on the search data in the network within the preset period of time.

In S202, the talent flow intention network is established based on the cross-regional job search behavior information.

The entire network includes search data of a variety of users in different regions. Due to a large amount of data, a parallel computing method may be adopted for operation, which uses a distributed system including but not limited to hadoop for distributed data storage and computing.

In this embodiment, in order to mine the cross-regional job search behavior information, there is a need to identify cross-city job search behaviors in the search data. The following steps may be specifically included.

(1) Job-related search records are filtered from the search data. For example, query keywords of the search records may be filtered to screen out job-related keywords, such as “job” and “job hunting”.

(2) The search records are deduplicated. A plurality of job search behaviors may exist in a plurality of search records of a plurality of consecutive sessions of a same user. In fact, this only corresponds to one search by one user. Based on the above, a plurality of search records at a same search originating position may be combined into one search record based on a time difference within a preset time length threshold range. It is to be noted that search positions in the network are latitude and longitude positions. During the search deduplication, a search originating position with a small floating change within a preset distance range may be considered as the same user’s position.

(3) A search starting region is identified by fuzzy positioning to acquire region information of a search starting point. Corresponding positions in the search records exist in the form of latitude and longitude coordinates. In order to mine cross-regional job search behaviors, there is a need to convert a position form represented by latitude and longitude into a position form represented by regions. Correspondingly, the search starting region is identified by fuzzy positioning in the search records to acquire region information of a search starting point, such as a province, a city, or a town. In this embodiment, the method may include, but is not limited to, judging whether the search starting point is in a polygon surrounded by an administrative region boundary by using a computational geometry algorithm based on the administrative region boundary, so as to match the search starting point with a corresponding administrative region.

(4) A job search destination is identified based on a text extraction technology through relevant text data in the search records.

Based on the above four steps, each search record may be converted into a two tuple (a start region, a destination region), which represents a cross-regional job search behavior from the start region to the destination region.

Next, the talent flow intention network is established based on the cross-regional job search behavior information. Specifically, the talent flow intention network may be constructed by taking regions in the cross-regional job search behavior information as nodes in the network, connection lines between nodes corresponding to two regions crossed by the cross-regional job search behavior information as edges, and a number of frequencies of the cross-regional job search behavior information within the preset time period as intensity of the corresponding edges.

That is, starting regions and destination regions in all two tuples (a start region, a destination region) mined are used as the nodes of the network respectively. In practical applications, the nodes may be cities, identities, and the like. Moreover, search records formed by the two tuples of the same start region and the same destination region are combined, the number of occurrence is counted as the intensity of the edge from the start region to the destination region, and then the talent flow intention network can be constructed. The flow intention network constructed in the construction manner is accurate and reliable, and can accurately reflect talent flow intention information in each region.

It is to be noted that the user’s job search behavior information includes a start region and a destination region, the start region is a region corresponding to the user’s location, and the destination region corresponds to a region where the user wants to apply for a job. Moreover, interchange between the start region and the destination region corresponds to different job search behavior information. Therefore, the edges of the talent flow intention network in this embodiment may be directed edges, so as to more accurately reflect the talent flow intention information.

Certainly, there is also a need to refer to indicators to be analyzed for the talent flow intention analysis. Some indicators only consider a size of talent flow and do not pay attention to inflow or outflow. In this case, directions of the edges of the talent flow intention network may not be required. Some indicators are required to consider inflow and outflow of talent, so the directions of the edges have to be considered.

Steps S201 to S202 are one specific implementation of step S101 in the embodiment shown in FIG. 1. In practical applications, cross-regional talent flow intention information may also be mined in other manners based on the search data in the network within the preset period of time to construct the talent flow intention network, which is not limited herein.

In S203, regional talent flow indicators of regions are analyzed based on the talent flow intention network.

Specifically, importance and structural features of each node on the talent flow intention network may be obtained with a network node analysis method, including, but not limited to, the following calculation methods of node centrality: degree centrality, betweenness centrality, pagerank, hyperlink-induced topic search (HITS), and black hole/volcano mining algorithms, and other universal or self-designed node characterization methods.

For example, outlets and outlets of the nodes can be calculated with the degree centrality algorithm, which represent regional talent inflow indicators and regional talent outflow indicators of the nodes respectively. The number of points on critical paths in the network to which the nodes belong may be calculated with the betweenness centrality algorithm, which is an indicator to identify the importance of the nodes in the talent flow intention network. The greater the value of the importance of the node, the more important the corresponding node in talent flow. The more frequent the inflow or outflow of talent, the greater the amount of flow. Probabilities of the nodes staying in random walk may be calculated with the pagerank algorithm. The higher the probability of a node, the more important the node. A probability indicator of retaining talent in a cross-regional job search can be identified. The higher the probability, the stronger the inflow of talent at the node. The obtained indicator can be used as a regional talent attraction indicator. Authority values of the nodes obtained with the HITS algorithm may be used as talent attraction indicators of the corresponding regions. Hub values are used as talent transfer capacity indicators of the corresponding regions. Black hole values of the nodes calculated with the black hole/volcano mining algorithm may be used as talent gathering power indicators of the corresponding regions. Volcanic values may be used as talent outflow intensity indicators of the corresponding regions.

In S204, a regional flow cluster is mined based on the talent flow intention network; and interregional flow indicators in the regional flow cluster are analyzed.

Network clustering and other methods can be adopted, including, but not limited to, label propagation, Louvain, spectral clustering, and other methods, to obtain regions closely related to labor flow to form the regional flow cluster. Moreover, the interregional flow indicators in the regional flow cluster may be further analyzed. For example, when the regional flow cluster includes A, B, and C regions, intensity of talent outflow from A to B and C, intensity of talent outflow from B to A and C, and intensity of talent outflow from C to A and B can be specifically analyzed. In addition, optionally, other flow indicators between different regions in the regional flow cluster can also be analyzed, which are not limited herein.

In this embodiment, indicators in step S203 and step S204 are analyzed at the same time. In practical applications, only the indicator in step S203 or step S204 may be analyzed.

In S205, the talent flow intention analysis result is displayed.

Specifically, the regional talent flow indicators of the regions analyzed in step S230 may be displayed. At the same time, the regional flow cluster mined and the interregional flow indicators in the regional flow cluster in step S204 may also be displayed. Specifically, directions and intensity of talent flow intentions in the talent flow intention network, attraction indicators of the regions, the regional flow cluster, and the interregional flow indicators in the regional flow cluster can be displayed with reference to the analysis results obtained in step S203 and step S204.

Further optionally, a query function may also be provided to query the regional flow cluster and relevant information of the related regional flow cluster.

Further optionally, based on the above embodiment, a talent flow intention analysis model may be trained based on the talent flow intention network and the talent flow intention analysis result.

In this embodiment, the training may be, but is not limited to, supervised training such as a neural network. Specifically, the talent flow intention network in a plurality of historical periods of time may be collected, and talent flow intention analysis results may be analyzed. Then, a talent flow intention analysis model is trained, so that the talent flow intention analysis model can predict the corresponding talent flow intention analysis result based on the talent flow intention network.

For example, with reference to the talent flow intention analysis result in the above embodiment, the talent flow intention analysis model is trained by using the talent flow intention network, corresponding regional talent flow indicators, the regional flow cluster, and the interregional flow indicators in the regional flow cluster. To enable the talent flow intention analysis model to learn a capability to predict indicators, the talent flow intention analysis model is trained by using the talent flow intention network and the corresponding indicators.

Further, after the talent flow intention analysis model is trained, in use, a target talent flow intention network in a time period of time may be acquired. Then, a target talent flow intention analysis model of the target talent flow intention network is predicated based on the target talent flow intention network by using a pre-trained talent flow intention analysis model. In this way, corresponding talent flow intention analysis results can be predicted based on the constructed talent flow intention analysis model, so that the talent flow intention analysis is more intelligent and more convenient.

In one embodiment of the present disclosure, unsupervised training methods such as Bayesian methods may also be used. Further optionally, sequential variations of the talent flow intention network can also be dynamically analyzed and predicted by using a statistical method or the like.

According to the method for cross-regional talent flow intention analysis in this embodiment, a talent flow intention network is established by mining cross-regional job search behavior information based on search data in a network within a preset period of time. Since sources of the search data are reliable, accurate, and real-time, accuracy and timeliness of the talent flow intention network can be effectively ensured. Then, regional talent flow indicators of the regions, the regional flow cluster, and the interregional flow indicators in the regional flow cluster can be accurately analyzed based on the talent flow intention network. Compared with offline manual surveys and analysis, the entire process requires no human participation, has lower costs, is accurate and reliable, has better real-time performance, can support a variety of analysis of different scales, and can help the government to understand a state of labor mobility in real time. In particular, with changes in talent flow resulting from important policies or important events, the government can be helped to formulate better development policies and bring better social benefits.

Besides, in this embodiment, the cross-regional talent flow intention analysis result can also be displayed, which is very intuitive, clear, and practical.

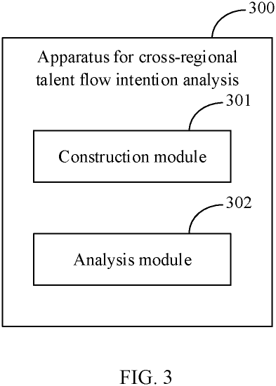

FIG. 3 is a schematic diagram according to a third embodiment of the present disclosure. As shown in FIG. 3, this embodiment provides an apparatus 300 for cross-regional talent flow intention analysis, including a construction module 301 configured to construct a talent flow intention network based on search data in a network within a preset period of time; and an analysis module 302 configured to perform cross-regional talent flow intention analysis based on the talent flow intention network to obtain a talent flow intention analysis result.

An implementation principle and a technical effect of the apparatus 300 for cross-regional talent flow intention analysis in this embodiment realizing cross-regional talent flow intention analysis by using the above modules are the same as those in the above related method embodiment. Details may be obtained with reference to the description in the above related method embodiment, and are not described herein.

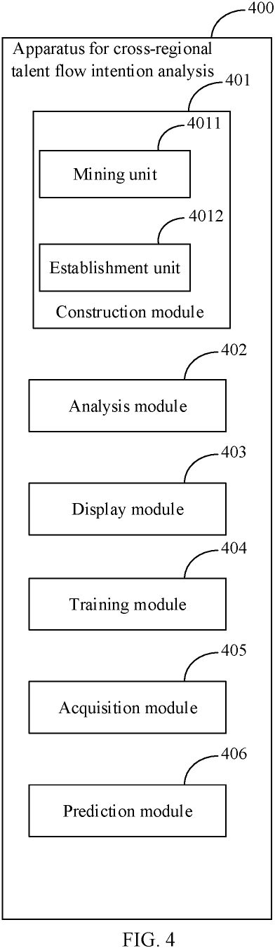

FIG. 4 is a schematic diagram according to a fourth embodiment of the present disclosure. As shown in FIG. 4, this embodiment provides an apparatus 400 for cross-regional talent flow intention analysis, including modules with the same names and the same functions as those in FIG. 3, i.e., a construction 401 and an analysis module 402.

In the apparatus 400 for cross-regional talent flow intention analysis in this embodiment, the analysis module 402 is configured to analyze regional talent flow indicators of regions based on the talent flow intention network; and/or mine a regional flow cluster based on the talent flow intention network; and analyze interregional flow indicators in the regional flow cluster.

In the apparatus 400 for cross-regional talent flow intention analysis in this embodiment, the construction module 401 is configured to a mining unit 4011 configured to mine cross-regional job search behavior information based on the search data in the network within the preset period of time; and an establishment unit 4012 configured to establish the talent flow intention network based on the cross-regional job search behavior information.

Further, the establishment unit 4012 is configured to construct the talent flow intention network by taking regions in the cross-regional job search behavior information as nodes in the network, connection lines between nodes corresponding to two regions crossed by the cross-regional job search behavior information as edges, and a number of frequencies of the cross-regional job search behavior information within the preset time period as intensity of the corresponding edges.

Further, in this embodiment, the edges of the talent flow intention network are directed edges.

As shown in FIG. 4, the apparatus 400 for cross-regional talent flow intention analysis in this embodiment further includes a display module 403 configured to display the talent flow intention analysis result.

As shown in FIG. 4, the s apparatus 400 for cross-regional talent flow intention analysis in this embodiment further includes a training module 404 configured to train a talent flow intention analysis model based on the talent flow intention network and the talent flow intention analysis result.

As shown in FIG. 4, the apparatus 400 for cross-regional talent flow intention analysis in this embodiment further includes an acquisition module 405 configured to acquire a target talent flow intention network; and a prediction module 406 configured to predict a target talent flow intention analysis model based on the target talent flow intention network by using the talent flow intention analysis model.

An implementation principle and a technical effect of the apparatus 400 for cross-regional talent flow intention analysis in this embodiment realizing cross-regional talent flow intention analysis by using the above modules are the same as those in the above related method embodiment. Details may be obtained with reference to the description in the above related method embodiment, and are not described herein.

Acquisition, storage, and application of users’ personal information involved in the technical solutions of the present disclosure comply with relevant laws and regulations, and do not violate public order and moral.

According to embodiments of the present disclosure, the present disclosure further provides an electronic device, a readable storage medium, and a computer program product.

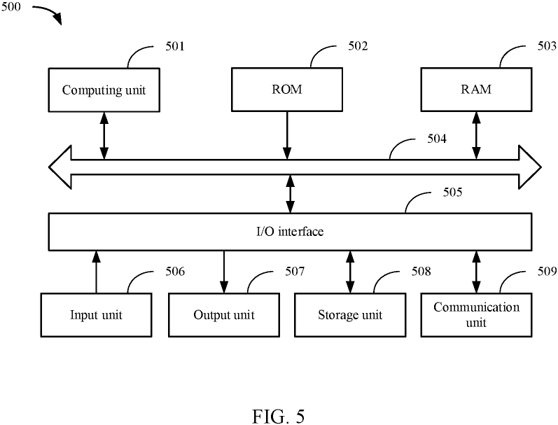

FIG. 5 is a schematic block diagram of an exemplary electronic device 500 configured to implement an embodiment of the present disclosure. The electronic device is intended to represent various forms of digital computers, such as laptops, desktops, workbenches, PDAs, servers, blade servers, mainframe computers and other suitable computers. The electronic device may further represent various forms of mobile devices, such as PDAs, cellular phones, smart phones, wearable devices and other similar computing devices. The components, their connections and relationships, and their functions shown herein are examples only, and are not intended to limit the implementation of the present disclosure as described and/or required herein.

As shown in FIG. 5, the device 500 includes a computing unit 501, which may perform various suitable actions and processing according to a computer program stored in a read-only memory (ROM) 502 or a computer program loaded from a storage unit 508 into a random access memory (RAM) 503. The RAM 503 may also store various programs and data required to operate the device 500. The computing unit 501, the ROM 502 and the RAM 503 are connected to one another by a bus 504. An input/output (I/O) interface 505 is also connected to the bus 504.

A plurality of components in the device 500 are connected to the I/O interface 505, including an input unit 506, such as a keyboard and a mouse; an output unit 507, such as various displays and speakers; a storage unit 508, such as disks and discs; and a communication unit 509, such as a network card, a modem and a wireless communication transceiver. The communication unit 509 allows the device 500 to exchange information/data with other devices over computer networks such as the Internet and/or various telecommunications networks.

The computing unit 501 may be a variety of general-purpose and/or special-purpose processing components with processing and computing capabilities. Some examples of the computing unit 501 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 501 performs the methods and processing described above, such as the method in the present disclosure. For example, in some embodiments, the method in the present disclosure may be implemented as a computer software program that is tangibly embodied in a machine-readable medium, such as the storage unit 508. In some embodiments, part or all of a computer program may be loaded and/or installed on the device 500 via the ROM 502 and/or the communication unit 509. One or more steps of the method in the present disclosure described above may be performed when the computer program is loaded into the RAM 503 and executed by the computing unit 501. Alternatively, in other embodiments, the computing unit 501 may be configured to perform the method in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the protection scope of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the protection scope of the present disclosure.

What is claimed is:

1. A method for cross-regional talent flow intention analysis, comprising:
constructing a talent flow intention network based on search data in a network within a preset period of time; and
performing cross-regional talent flow intention analysis based on the talent flow intention network to obtain a talent flow intention analysis result.

2. The method of claim 1, wherein the performing cross-regional talent flow intention analysis based on the talent flow intention network to obtain a talent flow intention analysis result comprises:
analyzing regional talent flow indicators of regions based on the talent flow intention network; and/or
mining a regional flow cluster based on the talent flow intention network; and analyzing interregional flow indicators in the regional flow cluster.

3. The method of claim 1, wherein the constructing a talent flow intention network based on search data in a network comprises:
mining cross-regional job search behavior information based on the search data in the network within the preset period of time; and
establishing the talent flow intention network based on the cross-regional job search behavior information.

4. The method of claim 3, wherein the establishing the talent flow intention network based on the cross-regional job search behavior information comprises:
constructing the talent flow intention network by taking regions in the cross-regional job search behavior information as nodes in the network, connection lines between nodes corresponding to two regions crossed by the cross-regional job search behavior information as edges, and a number of frequencies of the cross-regional job search behavior information within the preset time period as intensity of the corresponding edges.

5. The method of claim 4, wherein the edges of the talent flow intention network are directed edges.

6. The method of claim 1, subsequent to the performing cross-regional talent flow intention analysis based on the talent flow intention network to obtain a talent flow intention analysis result, further comprising:
displaying the talent flow intention analysis result.

7. The method of claim 1, wherein subsequent to the performing cross-regional talent flow intention analysis based on the talent flow intention network to obtain a talent flow intention analysis result, the method further comprises:
training a talent flow intention analysis model based on the talent flow intention network and the talent flow intention analysis result.

8. The method of claim 7, further comprising:
acquiring a target talent flow intention network; and
predicting a target talent flow intention analysis model based on the target talent flow intention network by using the talent flow intention analysis model.

9. The method of claim 2, wherein subsequent to the performing cross-regional talent flow intention analysis based on the talent flow intention network to obtain a talent flow intention analysis result, the method further comprises:
training a talent flow intention analysis model based on the talent flow intention network and the talent flow intention analysis result.

10. The method of claim 3, wherein subsequent to the performing cross-regional talent flow intention analysis based on the talent flow intention network to obtain a talent flow intention analysis result, the method further comprises:
training a talent flow intention analysis model based on the talent flow intention network and the talent flow intention analysis result.

11. An electronic device, comprising:
at least one processor; and
a memory communicatively connected with the at least one processor;
wherein the memory stores instructions executable by the at least one processor, and the instructions are executed by the at least one processor to enable the at least one processor to perform a method for cross-regional talent flow intention analysis, wherein the method comprises:
constructing a talent flow intention network based on search data in a network within a preset period of time; and
performing cross-regional talent flow intention analysis based on the talent flow intention network to obtain a talent flow intention analysis result.

12. The electronic device of claim 11, wherein the performing cross-regional talent flow intention analysis based on the talent flow intention network to obtain a talent flow intention analysis result comprises:
analyzing regional talent flow indicators of regions based on the talent flow intention network; and/or
mining a regional flow cluster based on the talent flow intention network; and analyze interregional flow indicators in the regional flow cluster.

13. The electronic device of claim 11, wherein the constructing a talent flow intention network based on search data in a network comprises:
mining cross-regional job search behavior information based on the search data in the network within the preset period of time; and
establishing the talent flow intention network based on the cross-regional job search behavior information.

14. The electronic device of claim 13, wherein the establishing the talent flow intention network based on the cross-regional job search behavior information comprises:
constructing the talent flow intention network by taking regions in the cross-regional job search behavior information as nodes in the network, connection lines between nodes corresponding to two regions crossed by the cross-regional job search behavior information as edges, and a number of frequencies of the cross-regional job search behavior information within the preset time period as intensity of the corresponding edges.

15. The electronic device of claim 14, wherein the edges of the talent flow intention network are directed edges.

16. The electronic device of claim 11, subsequent to the performing cross-regional talent flow intention analysis based on the talent flow intention network to obtain a talent flow intention analysis result, further comprising:
displaying the talent flow intention analysis result.

17. The electronic device of claim 11, subsequent to the performing cross-regional talent flow intention analysis based on the talent flow intention network to obtain a talent flow intention analysis result, the method further comprises:
training a talent flow intention analysis model based on the talent flow intention network and the talent flow intention analysis result.

18. The electronic device of claim 17, further comprising:
acquiring a target talent flow intention network; and
predicting a target talent flow intention analysis model based on the target talent flow intention network by using the talent flow intention analysis model.

19. The electronic device of claim 12, subsequent to the performing cross-regional talent flow intention analysis based on the talent flow intention network to obtain a talent flow intention analysis result, the method further comprises:
training a talent flow intention analysis model based on the talent flow intention network and the talent flow intention analysis result.

20. A non-transitory computer readable storage medium with computer instructions stored thereon, wherein the computer instructions are used for causing a method for cross-regional talent flow intention analysis, wherein the method comprises:
constructing a talent flow intention network based on search data in a network within a preset period of time; and
performing cross-regional talent flow intention analysis based on the talent flow intention network to obtain a talent flow intention analysis result.
